(19) United States
(12) Patent Application Publication
(10) Pub. No.: US 2024/0251935 A1
(43) Pub. Date: Aug. 1, 2024

(54) Smart Toothbrush Cover

(71) Applicant: Ryan Galladora, Ponchatoula, LA (US)

(72) Inventor: Ryan Galladora, Ponchatoula, LA (US)

(21) Appl. No.: 18/162,158

(22) Filed: Jan. 31, 2023

(51) Int. Cl. A46B 17/04; A45D 44/18; G07C 9/00; G07C 9/25

(52) U.S. Cl. CPC A46B 17/04; A45D 44/18; G07C 9/00309; G07C 9/00563; G07C 9/257; A46B 2200/1066

(57) ABSTRACT

A toothbrush protection system and apparatus configured to securely lock around a toothbrush to prevent contamination as well as to prevent unauthorized use or malice. A biometric lock is disposed within the device and is configured to permit access to the toothbrush only by authorized users. Rubber gaskets prevent malicious contamination by isolating the toothbrush head. An internal battery disposed within a housing powers the biometric component. A Bluetooth transponder facilitates connection of the device to a mobile device such as a smartphone in order to track when, and by whom, the device is opened. Tracking is facilitated via a mobile device application.

### FIELD OF THE PRESENT INVENTION

The present invention relates to hygiene equipment, and more specifically relates to a toothbrush cover configured to secure a user's toothbrush from contaminates, malice, and use by others via a smart housing. The housing seals the brush head and body with a biometric lock while providing air access.

### BACKGROUND OF THE PRESENT INVENTION

Hygiene products are known to work best when they are kept clean and are used often. Products such as toothbrushes are configured to be used multiple times daily, however they are often prone to contamination by airborne debris. Additionally, given that they are used multiple times per day, many individuals opt to leave their toothbrush out of a cabinet, especially newer electric toothbrushes which must remain on a charger between uses to ensure that their internal battery remains charged enough for the next use. This leaves one's toothbrush susceptible to contamination by airborne debris.

Contamination can be of concern when a bathroom is shared with others, such as roommates, flatmates, or even strangers, such as in a hostel setting. In such instances, contamination may be deliberate as a result of malicious intent by ones roommate. If there were a way to secure and lock one's toothbrush such that the risk of contamination by airborne debris or malice is eliminated, the safety of the toothbrush could be maintained, and one need not worry about malicious destruction or contamination of one's toothbrush by roommates. Additionally, unauthorized use of the toothbrush, such as by a roommate to clean his or her teeth, or worse, to clean the carpet or the toilet, could be eliminated.

While toothbrush head covers are available on the market, these devices are limited in scope, and do not offer adequate protection since they do not securely lock closed. Instead, these devices are configured to merely protect the toothbrush head from airborne contaminants, rather than keep other individuals from using the brush, or from deliberately contaminating the brush head.

Thus, there is a need for a new form of toothbrush protection apparatus configured to lock closed around the brush and/or brush head, preventing any and all access to the brush except by the owner. Such a device is preferably equipped with at least one biometric locking mechanism configured to ensure protection of the toothbrush in the absence of the owner.

### SUMMARY OF THE PRESENT INVENTION

The present invention is a toothbrush protection device and system configured to prevent contamination of a toothbrush from airborne contaminants or deliberate malicious destruction. The present invention is equipped with a sealable housing configured to securely seal around a head of a conventional toothbrush. Rubber or silicone gaskets are present around an opening of the housing to ensure that a secure seal is established around the neck of the toothbrush. A biometric sensor such as a fingerprint reader and/or camera-based facial recognition system is present on an exterior of the housing of the apparatus, and is configured to manipulate a locking mechanism to facilitate access to the toothbrush solely by authorized users. A Bluetooth™ module is preferably present disposed in communication with a Programmable Logic Controller (PLC) to facilitate wireless connection of the apparatus to a mobile device via a mobile device application. The mobile device application is configured to monitor all access to the toothbrush, including failed attempts to access the toothbrush, and report to the toothbrush owner via his/her mobile device.

These together with still other objects of the invention, along with the various features of novelty which characterize the invention, are pointed out with particularity in the claims annexed to and forming a part of this disclosure. For a better understanding of the invention, its operating advantages and the specific objects attained by its uses, reference should be made to the accompanying drawings and descriptive matter in which there are illustrated preferred embodiments of the invention.

The following brief and detailed descriptions of the drawings are provided to explain possible embodiments of the present invention but are not provided to limit the scope of the present invention as expressed herein this summary section.

### BRIEF DESCRIPTION OF THE DRAWINGS

The accompanying drawings, which are incorporated herein and form a part of the specification, illustrate the present invention and, together with the description, further serve to explain the principles of the invention and to enable a person skilled in the pertinent art to make and use the invention.

The present invention will be better understood with reference to the appended drawing sheets, wherein:

FIG. 1 exhibits the present invention from the front, detached from a toothbrush.

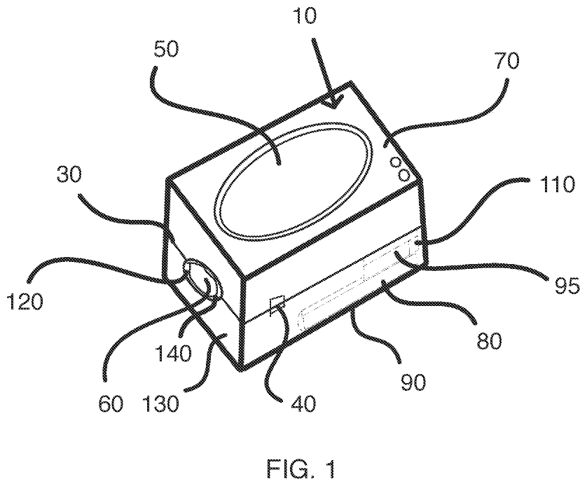

FIG. 2 shows the present invention affixed to a conventional toothbrush as seen from the front, with the apparatus securely locked around the toothbrush.

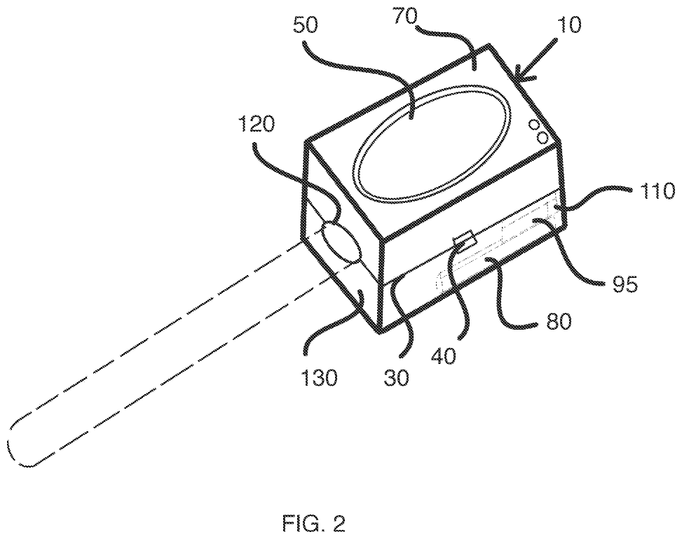

FIG. 3 exhibits a flow chart detailing the process of use of the present invention.

FIG. 4 depicts a view of an alternate embodiment of the present invention, shown from the top side.

### DETAILED DESCRIPTION OF THE PREFERRED EMBODIMENT

The present specification discloses one or more embodiments that incorporate the features of the invention. The disclosed embodiment(s) merely exemplify the invention. The scope of the invention is not limited to the disclosed embodiment(s).

References in the specification to “one embodiment,” “an embodiment,” “an example embodiment,” etc., indicate that the embodiment described may include a particular feature, structure, or characteristic, but every embodiment may not necessarily include the particular feature, structure or characteristic. Moreover, such phrases are not necessarily referring to the same embodiment, Further, when a particular feature, structure, or characteristic is described in connection with an embodiment, it is submitted that it is within the knowledge of one skilled in the art to effect such feature, structure, or characteristic in connection with other embodiments whether or not explicitly described.

The present invention is a toothbrush protection system and apparatus configured to protect and isolate a toothbrush from contaminates, malicious intent, and unauthorized use. The present invention is equipped with a housing (10) having a generally rectangular frame conducive to contain a conventional toothbrush head. The housing (10) is equipped with an access door (30) which is configured to open to facilitate the deposit and retrieval of the toothbrush from an interior (60) of the apparatus. The access door (30) preferably pivots about at least one hinge (45). The access door (30) is equipped with a biometric lock (40) which is managed by at least one biometric sensor (50) such as a fingerprint reader. The biometric sensor (50) is disposed on an exterior (70) of the housing (10).

To power the at least one biometric sensor (50) at least one battery (80) is disposed within a battery compartment (90) disposed within the housing (10). The at least one battery (80) is connected to the at least one biometric sensor (50) via at least one wire (100). A Bluetooth module (110) is additionally present within the housing (10), and may be disposed in fixed communication with a PLC (95) or System-on-a-Chip configured to manage the biometric capabilities of the present invention, as well as to facilitate connection of the present invention to a mobile device via the Bluetooth module (110). Conventional flash memory is preferably available in communication with the PLC to store biometric data of the owner. At least one LED bulb (65) may be present on the housing (10) to indicate when the device is unlocked and/or to indicate when

A neck hole (120) is present at a bottom (130) of the housing, and is configured to permit passage of the neck of the toothbrush while ensuring that the head of the toothbrush remains sealed within the housing (10). Gaskets (140) are included with the purchase of the apparatus of the present invention in assorted sizes. The gaskets (140) are configured to be affixed within the neck hole (120). The toothbrush owner must select and install the correctly sized gaskets for his or her unique toothbrush to ensure a secure seal around the neck of the toothbrush when disposed within the neck hole (120).

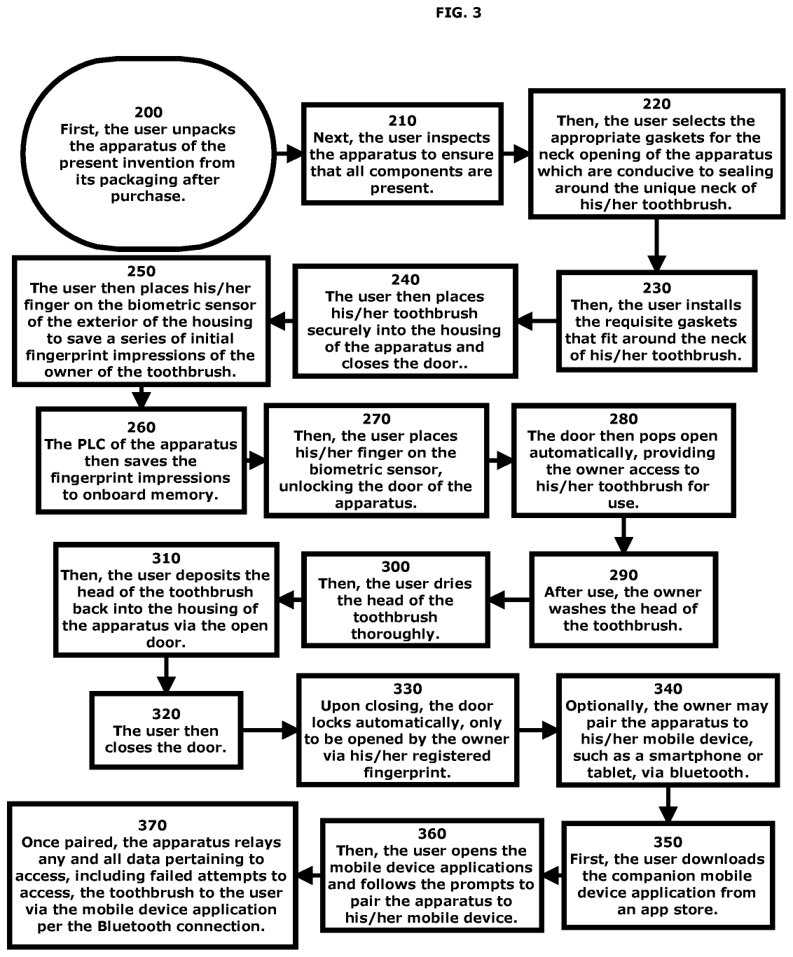

The process of use of the apparatus of the present invention by a user, as seen in FIG. 3, is preferably as follows:
1. First, the user unpacks the apparatus of the present invention from its packaging after purchase. (200)
2. Next, the user inspects the apparatus to ensure that all components are present. (210)
3. Then, the user selects the appropriate gaskets for the neck opening of the apparatus which are conducive to sealing around the unique neck of his/her toothbrush. (220)
4. Then, the user installs the requisite gaskets that fit around the neck of his/her toothbrush. (230)
5. The user then places his/her toothbrush securely into the housing of the apparatus and closes the door. (240)
6. The user then places his/her finger on the biometric sensor of the exterior of the housing to save a series of initial fingerprint impressions of the owner of the toothbrush. (250)
7. The PLC of the apparatus then saves the fingerprint impressions to onboard memory. (260). At least one LED light of the housing preferably illuminates to indicate that the fingerprints have been saved successfully. Alternately, facial impressions, captured by a camera of the housing, may be saved to onboard memory facilitating facial recognition.
8. Then, the user places his/her finger on the biometric sensor, unlocking the door of the apparatus. (270) Alternately, a camera of the housing captures dimensions of the face of the user to inform facial recognition software present on the PLC, configured to confirm or deny the identity of the user.
9. The door then pops open automatically, providing the owner access to his/her toothbrush for use. (280) In the event that the biometric sensor does not perceive a match for a fingerprint or face (in the case of facial recognition) in memory on the PLC, the lock is not unlocked, and the door does not open.
10. After use, the owner washes the head of the toothbrush. (290)
11. Then, the user dries the head of the toothbrush thoroughly. (300)
12. Then, the user deposits the head of the toothbrush back into the housing of the apparatus via the open door. (310)
13. The user then closes the door. (320)
14. Upon closing, the door locks automatically, only to be opened by the owner via his/her registered fingerprint. (330)
15. Optionally, the owner may pair the apparatus to his/her mobile device, such as a smartphone or tablet, via bluetooth. (340)
16. First, the user downloads the companion mobile device application from an app store such as the Apple™ AppStore or Google™ Playstore™. (350)
17. Then, the user opens the mobile device applications and follows the prompts to pair the apparatus to his/her mobile device. (360)
18. Once paired, the apparatus relays any and all data pertaining to access, including failed attempts to access, the toothbrush to the user via the mobile device application per the Bluetooth connection. (370). In the event that the user's device is out of range of the Bluetooth module of the present invention, the tracking data is stored until the user is within range, or manually reconnects to the apparatus.

It should be understood that some embodiments of the present invention may exhibit different shapes and sizes of housing (10). For example, a smaller embodiment may be manufactured which is tailored for use by youth for youth toothbrushes. Additionally, it should be understood that the housing (10) of the present invention may be made available in an assortment of colors, textures, and patterns, and may be equipped with logos as desired. The housing (10) of the present invention is preferably fashioned of a high-density plastic which is durable for extended use. Further, it should be noted that the opening disposed behind the access door (30) are preferably beveled and/or rounded to prevent sharp edges, preventing injury of the user when inserting or removing the toothbrush head from the interior (20) of the housing (10) of the present invention.

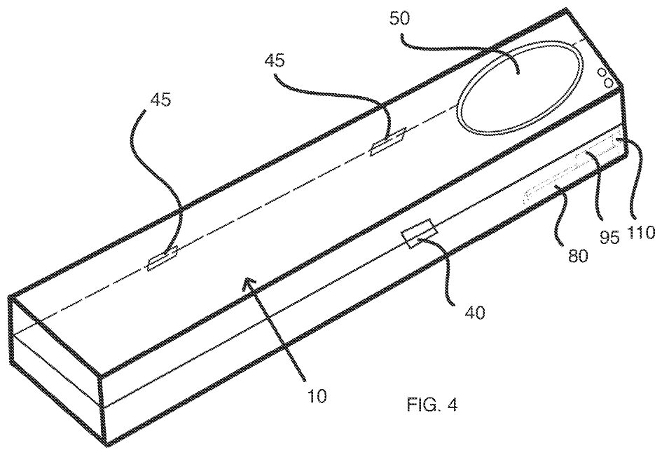

It should be noted that in some alternate embodiments of the present invention, the housing (10) may be longer so as to encompass the entirety of the toothbrush, including the head, neck, and handle of the toothbrush. In such embodiments, the totality of the toothbrush is protected, and is preferably sealed with a water-tight gasket or O-ring. Additionally, it should be understood that in such embodiments, the housing (10) preferably splits apart about the at least one hinge (45) to provide access to the toothbrush contained therein by authorized users of the toothbrush. An example of this alternate embodiment is depicted in FIG. 4.

Additionally, some embodiments of the present invention may be equipped with a cleaning mechanism configured to enable the present invention to clean the toothbrush head while it is stored and locked within the housing (10). Such embodiments preferably contain a UV light and/or a sonic cleaning mechanism configured to kill or remove bacteria, dust, and debris from the toothbrush head.

Having illustrated the present invention, it should be understood that various adjustments and versions might be implemented without venturing away from the essence of the present invention. Further, it should be understood that the present invention is not solely limited to the invention as described in the embodiments above, but further comprises any and all embodiments within the scope of this application.

The foregoing descriptions of specific embodiments of the present invention have been presented for purposes of illustration and description. They are not intended to be exhaustive or to limit the present invention to the precise forms disclosed, and obviously many modifications and variations are possible in light of the above teaching. The exemplary embodiment was chosen and described in order to best explain the principles of the present invention and its practical application, to thereby enable others skilled in the art to best utilize the present invention and various embodiments with various modifications as are suited to the particular use contemplated.

I claim:

1. A toothbrush vault configured to securely contain and protect a toothbrush comprising:
a housing, said housing having an interior and an exterior;
an access door, said access door present on said housing;
at least one hinge, said at least one hinge disposed in communication with said access door and said housing;
a lock, said lock disposed in communication with said access door and said housing;
at least one biometric sensor, said at least one biometric sensor disposed on said exterior of said housing;
a programmable logic controller (PLC), said programmable logic controller disposed within said housing;
wherein said programmable logic controller is disposed in communication with said at least one biometric sensor and said lock via at least one wire;
a Bluetooth radio, said Bluetooth radio disposed in communication with said programmable logic controller;
wherein said access door is configured to pivot open about said at least one hinge when said lock is unlocked via said at least one biometric sensor; and
a battery, said battery disposed in communication with said programmable logic controller.

2. The apparatus of claim 1, wherein said housing exhibits dimensions greater than that of the toothbrush.

3. The apparatus of claim 1, wherein said housing exhibits dimensions greater than a head of the toothbrush.

4. The apparatus of claim 1, wherein said at least one biometric sensor is a fingerprint reader.

5. The apparatus of claim 1, wherein said at least one biometric sensor is a camera configured to facilitate the use of facial recognition software present on said programmable logic controller.

6. The apparatus of claim 1, wherein said Bluetooth radio is configured to connect to a mobile device to convey data pertaining to both attempted and successful unlock attempts of said lock.

7. The apparatus of claim 6, wherein said at least one biometric sensor is a fingerprint reader.

8. The apparatus of claim 6, wherein said at least one biometric sensor is a camera configured to facilitate the use of facial recognition software present on said programmable logic controller.

9. A method of controlling access to a toothbrush owned by an owner via a locking toothbrush housing comprising:
placing the toothbrush into the housing;
closing the housing;
training a programmable logic controller on biometric data of the owner via a biometric sensor;
the programmable logic controller saving the biometric data to memory, creating saved biometric data;
a lock of the housing locking an access door of the housing;
at least one LED light illuminating to indicate the access door has been successfully locked;
the owner supplying instant biometric data to at least one biometric sensor;
the programmable logic controller comparing the instant biometric data to the saved biometric data;
the lock of the housing unlocking upon the programmable logic controller matching the instant biometric data to the saved biometric data;
the lock of the housing remaining locked upon the programmable logic controller failing to match the instant biometric data to the saved biometric data; and
the access door opening to facilitate retrieval of the toothbrush of the owner.

10. The method of claim 9, wherein the biometric data are fingerprint scans.

11. The method of claim 9, wherein the biometric data are facial scans.
